(19) United States
(12) Patent Application Publication
(10) Pub. No.: US 2016/0042367 A1
(43) Pub. Date: Feb. 11, 2016

(54) Networked Location Targeted Communication and Analytics

(71) Applicant: Ottemo, Inc., Seattle, WA (US)

(72) Inventors: James W. VASTBINDER, JR., Bothell, WA (US); Gavin L. Smith, Lynnwood, WA (US); Lee D. Smith, Seattle, WA (US); Maaz H. Ghani, Redmond, WA (US)

(21) Appl. No.: 14/819,240

(22) Filed: Aug. 5, 2015

Related U.S. Application Data
(60) Provisional application No. 62/033,535, filed on Aug. 5, 2014.

(51) Int. Cl. G06Q 30/02; H04W 4/04

(52) U.S. Cl. CPC G06Q 30/0201; H04W 4/04

(57) ABSTRACT

In certain examples, systems and methods here may use a combination of GPS location data provided by a user's device and the use of low-energy beacons in a shopping location which interact in real time with a user's device to enable the targeted interactions. User flow through a retail shopping location is collected and then mapped to provide interaction data used to present targeted unique interactions and experiences for each user.

### CROSS REFERENCE

This application relates to and claims priority from US Provisional application US 62/033,535 which was filed on 5 Aug. 2014 all of which is incorporated herein by reference.

### FIELD

This application relates to the field of networked computers, location detection and data storage and analytics.

### BACKGROUND

Previously it was difficult to target time sensitive relevant information in real time to users based on their location, both inside and outside a physical retail location, for shopping experiences.

### SUMMARY

In certain examples, systems and methods here may use a combination of GPS location data provided by a user's device and the use of low-energy beacons in a shopping location which interact in real time with a user's device to enable the targeted interactions. User flow through a retail shopping location is collected and then mapped to provide interaction data used to present targeted unique interactions and experiences for each user.

### BRIEF DESCRIPTION OF THE FIGURES

FIG. 1 is an example network diagram, which may be used to implement certain example embodiments described here.

FIG. 2 is an example diagram of a client device, which may be used to implement certain example embodiments described here.

FIG. 3 is an example diagram of a network server, which may be used to implement certain example embodiments described here.

FIG. 4 is an example diagram of a network server, which may be used to implement certain example embodiments described here.

FIG. 5 is an example diagram of a system, which may be used to implement certain example embodiments described here.

FIG. 6 is another example diagram of a system, which may be used to implement certain example embodiments described here.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

### Overview

With the advent of smartphone and smart wearable technologies, the consumer interaction with the physical storefront can be enhanced. Such enhancement may be accomplished by leveraging individual and collective customers' online identities and social networks to target information and specials to consumers, as they are physically located in a shopping environment. Thus, according to this disclosure, relevant time-sensitive alerts and in-context notifications may be sent to a client device associated with a user while the user is shopping, based on the user location as well as social network and other inputs. Interaction with an application running on a user mobile device may be utilized. Such an arrangement could help foster customer loyalty as well as target individual and groups of customer desires. In certain example embodiments, low energy such as Bluetooth low energy BLE, and/or Wi-Fi and cellular communication devices may be used to send and receive information to and from customer smartphones and wearables for location identification as well as communication of information.

In order to drive the information and tailor it to individual users, a back end system can be used for analytics and data storage. Such a back end could also be used to interface with third party retailers in order to find and push information to users. It could be used to collect and analyze data including shopping habits of users as well as retail promotional habits.

It should be noted that the terms user equipment, clients, client devices, mobile devices, etc. could be used to describe any manner of wireless communicating computer device such as but not limited to smartphones, tablet computers, phablet computers, personal assistant computers, laptop computers, wearables such as watches, glasses, or any other computing device such as automobiles with computers and wireless communication systems as well. It should also be noted that wireless communications as described here could be any kind of wireless data communication such as cellular, LTE, 3G, 4G, pico cell, nano cell, Wi-Fi, near field communication NFC, low energy communication such as Bluetooth (BLE), or any other kind of wireless communication system which computers may utilize.

### Example Network

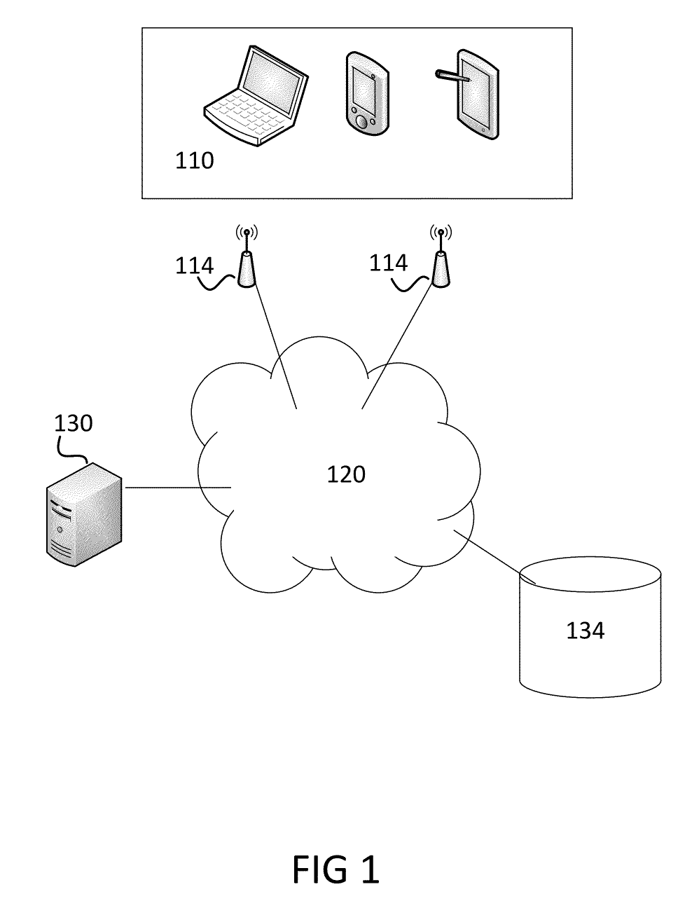

FIG. 1 shows an example network that could be used to implement certain example embodiments here. In the example, any number of client devices 110 are shown in communication with any number of wireless access points 114 such as a Wi-Fi access point as example and/or BLE, and a network 120. The network 120 is shown allowing communication with the access points 114 and a back end system 130. Also shown is a data storage 134 which in the example is shown as a networked storage but could be a local storage or combination of the two.

As will be described below, in the beacon examples, the access points 114 in the example of FIG. 1 may be used for finding the location of the client devices 110. This could be inside as in a mall or shopping environment, or could be outside, as along a road or in a parking lot or shopping complex. Such beacons 114 could also be used for communicating with user devices 110, user devices 110 then communicate directly with back end system 130 passing location data from beacons 114 which allows back end system 130 to send and receive information about promotions as well as collect data from the user devices and store it in data storage 134 to create unique profiles for each user device 110.

### Example Client Device

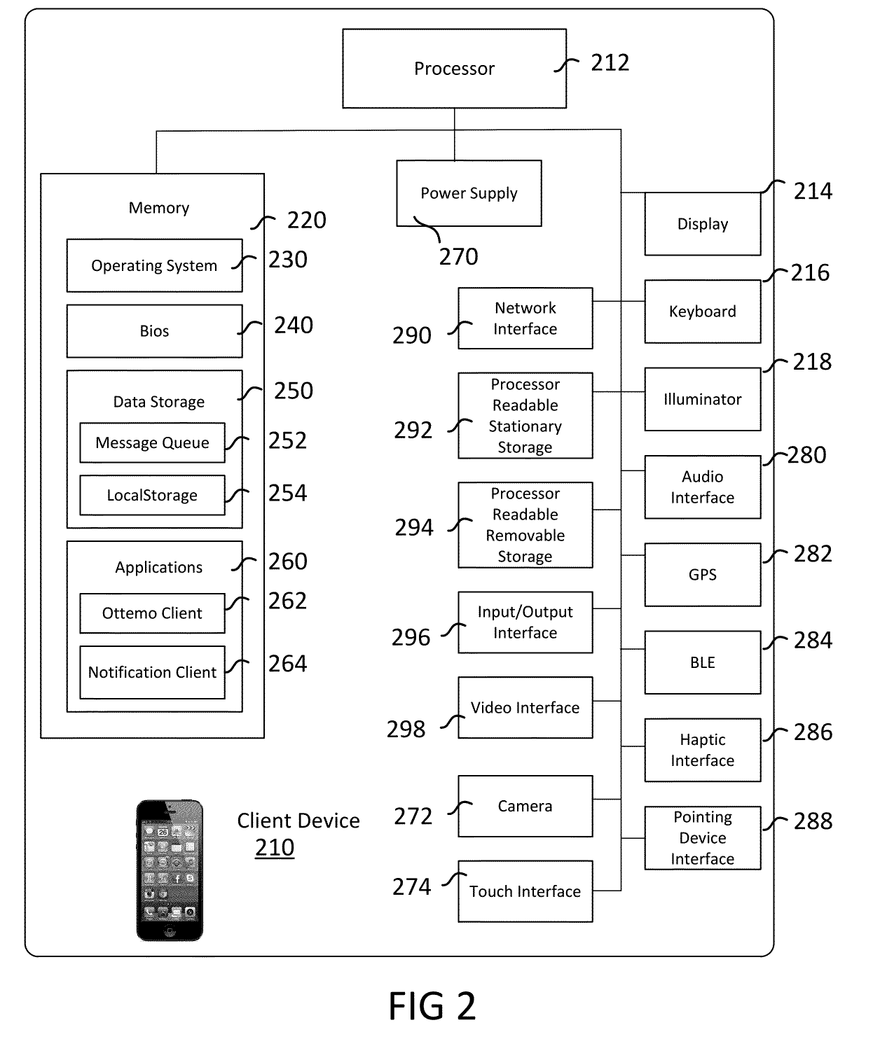

FIG. 2 shows an example client device and the various hardware and software components it may use in the examples described here.

In the example, the client device 210 may include many components which may allow it to operate as described herein. The example of FIG. 2 includes a processor 212 in communication with a memory 220. The memory 220 includes an operating system 230, a bios 240 a data storage 250 with a message queue 252 and Local storage 254 as well as applications 260 with a client 262 and notification client 264. The processor is also in communication with a power supply 270 as well as other features such as, for example but not limited to, a display 214, keyboard or other input 216, illuminator 218, as well as camera 272 a touch interface 274, an audio interface 280 a global positioning system GPS or other location detection system 282 a BLE 284 a haptic interface 286 a pointing device interface 288 and a network interface 290. Also included in the example are a processor readable stationary storage 292, a processor readable removable storage 294, an input/output interface 296 and a video interface 298.

### Example Server Device

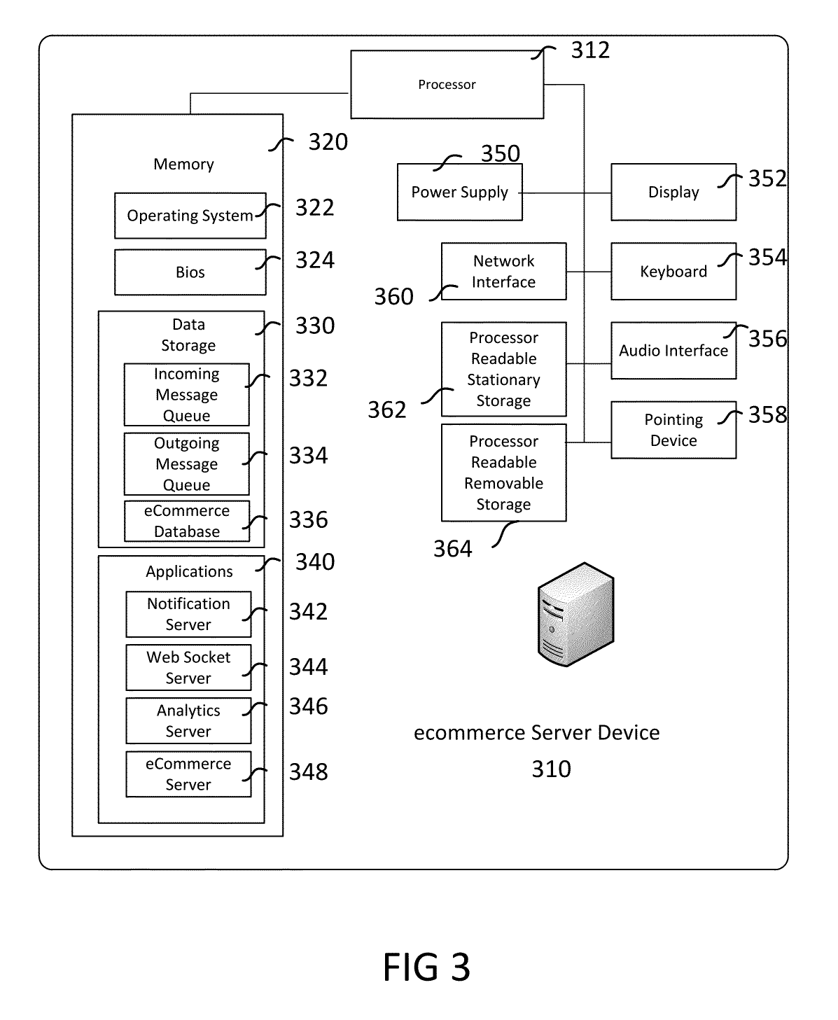

FIG. 3 shows an example e commerce server device 310 may include hardware and software components which may allow it to operate as described herein. Such servers could comprise a back end system as described here, with or without other components and/or servers and data storage. The e commerce server device 310 includes a processor 312 in communication with a memory 320. The memory 320 includes an operating system 322 a bios 324, a data storage 330 with an incoming message queue 332 an outgoing message queue 334 and an ecommerce database 336. The memory 320 also includes applications 340 with a notification server 342 a web socket server 344 an analytics server 346 and an ecommerce server 348. The example ecommerce server 310 also includes, in communication with the processor 312 a power supply 350 a display 352 a keyboard or other input device 354 an audio interface 356 a pointing device 358 as well as a network interface 360 a processor readable stationary storage 362 and a processor readable removable storage 364.

### Example Marketing and Analytics Device

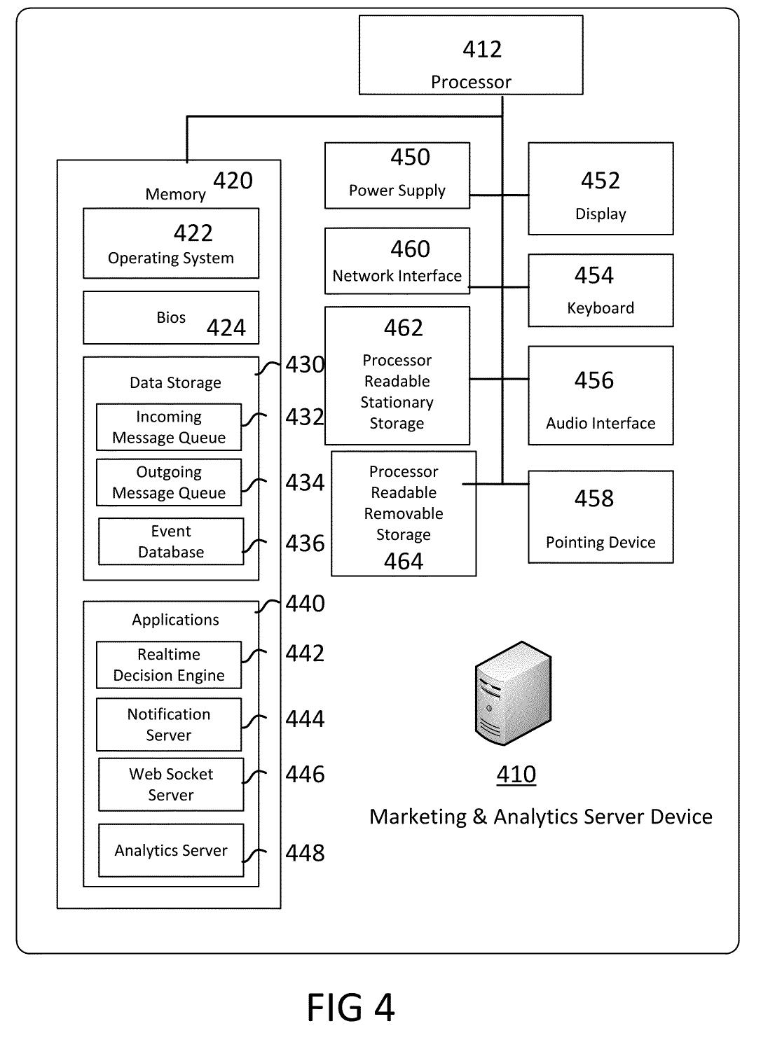

FIG. 4 shows an example marketing and analytics server device and the various hardware and software components it may use in the examples described here.

FIG. 4 marketing and analytics server device 410 may include many components which may allow it to operate as described herein. Such servers could comprise a back end system as described here, with or without other components and/or servers and data storage. The marketing and analytics server device 410 example in FIG. 4 includes a processor 412 in communication with a memory 420. The memory 420 includes an operating system 422 and a bios 424 as well as a data storage 430 including an incoming message queue 432 an outgoing message queue 434 and an event database 436. Also, the memory includes applications 440 with a real time decision engine 442 a notification server 44 a web socket server 446 and an analytics server 448. The processor 412 is also in communication with a power supply 450, a display 252 a keyboard 454 an audio interface 456 a pointing device 458, a network interface 460 a processor readable stationary storage 462 and a processor readable removable storage 464.

### Back End System Examples

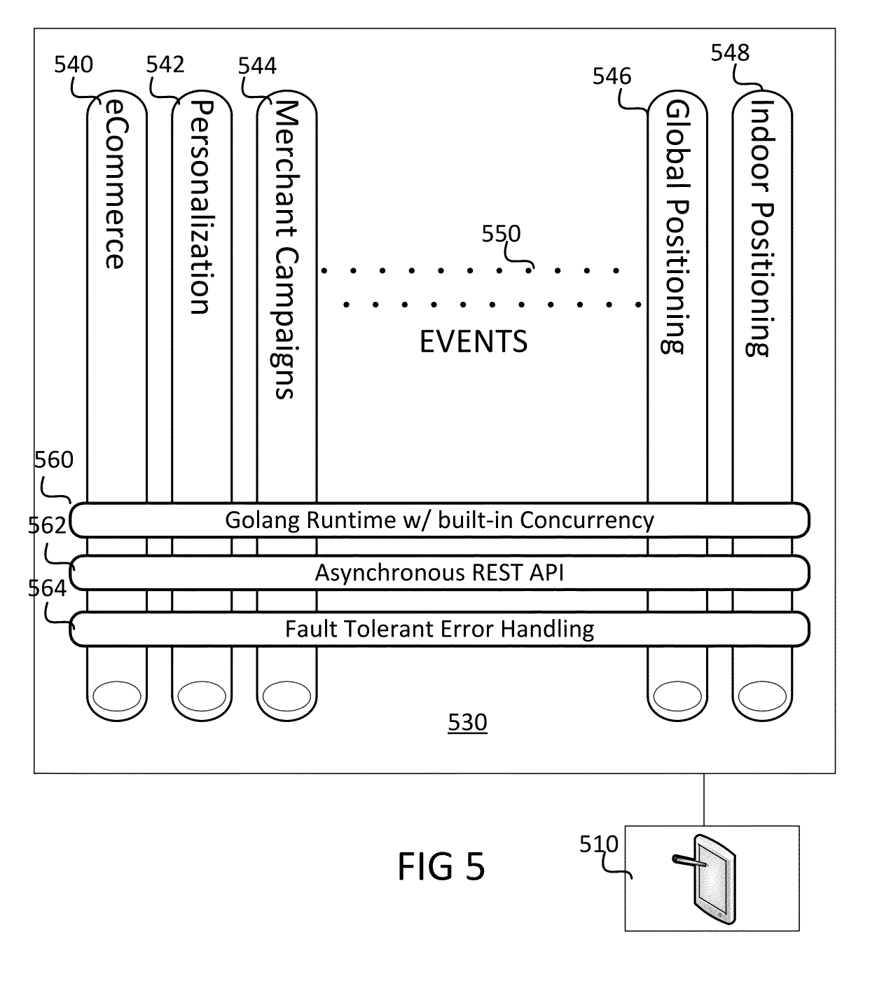

FIG. 5 shows portions of an example back end system, which can be used by the systems here in certain example embodiments. Using such systems, retail information, event information, and consumer interaction information may be managed by an event database component. By utilizing information regarding user-specific events, machine learning protocols may be used to generate unique user-specific enhancements of a user's shopping experience by targeting information to them in a timely manner.

The example of FIG. 5 shows such a back end system 530 in communication with various client devices 510 as discussed in FIG. 1. The system of FIG. 5 includes various components which are used by the system to decide what information to send the clients and when to send it. Such example components include an ecommerce component 540, personalization component 542, and merchant campaigns 544. Additionally, location information from a Global Positioning System 546 and/or Indoor Positioning System 548 may also be used to make those decisions. Events 550 such as information from the positioning components inform the other components, and are used to trigger information to be sent to a particular client 510.

Ecommerce may be statistics and heuristics known about ecommerce genres and is the basis for the trading of products and services over the internet using devices connected to the internet. For example, a website with the primary purpose for the sale of clothing and accessories targeted at males ages 13 to 28. While commerce used to be primarily contracted in person, today it is possible to sell many types of services, product and even pre-sell these same products and services through a website or application running on a mobile device, the primary difference being the communication happens across the internet. Ecommerce may be direct to consumers, businesses selling to business or even online marketplaces where many sellers with a commonality sell like, but unique products and services, for example a music marketplace where musicians of different genres sell their music through the same web site.

Personalization may be based on information gathered about individual users or groups of users. For example, information from a user's social network profile may be used. Demographic information known about individual or groups of users could be used. Habits and search information known to be used by an individual or group may be used. For example, a user may state on a social networking website that she loves soccer. This same user is known to be 30 years old and living in France. This user may also be known to search for soccer cleats online Such information could be used to customize communications to her.

Merchant campaigns may be any of various promotions that a merchant may wish to communicate to consumer users. Such campaigns may include information regarding discounts, deals, promotions, or any other kind of pushed or pulled information.

The software interfaces, to make the decisions may include any number of things such as a compiler such as Golang Runtime with built in concurrency 560, an application program interface (API) such as an asynchronous REST API 562, and fault tolerant error handling 564 portion.

### More Back End Examples

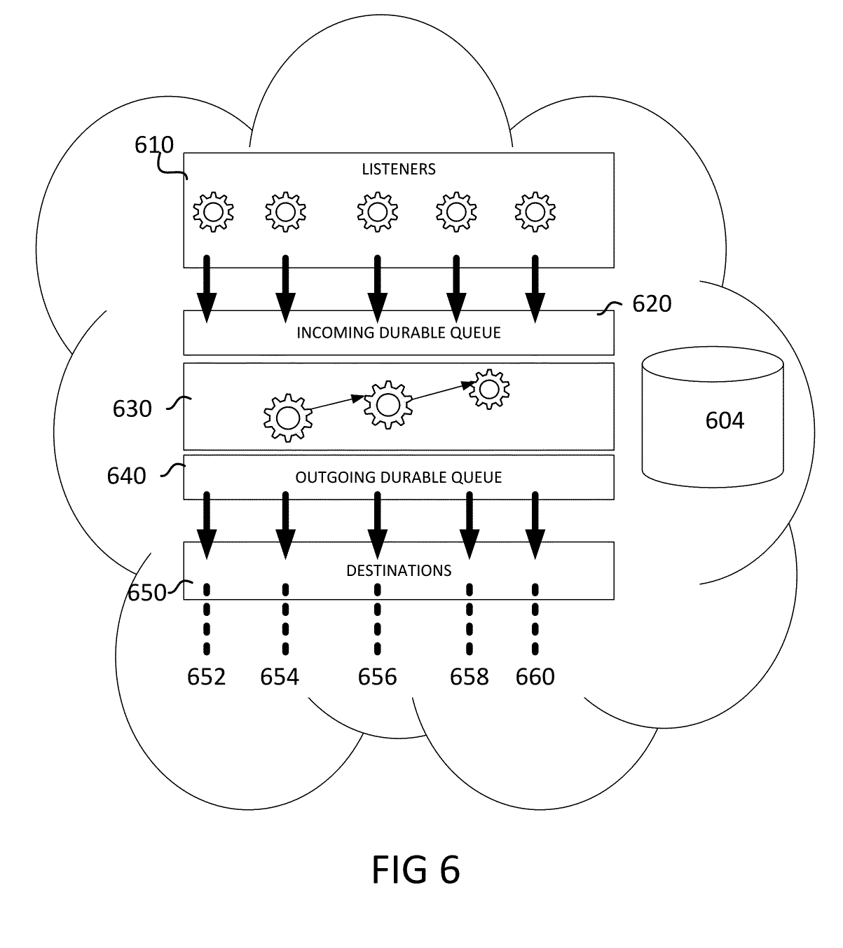

FIG. 6 shows another example back end system that may be used in certain example embodiments herein. In the example of FIG. 6, the data storage 604 may be used to store and retrieve data collected from the various clients as well as merchants.

Listeners 610 are unique collectors of event data coming from user devices which includes location data, time, user device id, devices interacting with over GPS, WiFi and BLE. The Listeners 610 may include any of various examples such as Custom, Batch Upload, Social Networks, Socket, and HTTP. The information from these Listeners 610 is collected by an incoming durable queue 620. Then, using this information, real time stream processing may take place using the Rules Engine 630. Once decisions are made, they may be sent to an outgoing durable queue 640 for client destinations 650 such as Just in Time alerts 652, Streaming Event Based Offers 654, Partner Notifications 656, foundation server, 658 and batch processing 660.

Listeners 610 may be specific event listeners, which collect event data specific to an activity. For a given activity fired by a user action and sent to the listener 610 it is sent to a Durable Queue 620 and forwarded to a Rules Engine 630 to be processed and stored in a Data Warehouse 604. Once activities have been processed by the Rules Engine 630, time sensitive Targeted Notifications 652, 654, 656, 658, 660 are passed to a second Durable Queue 650 to be sent to user devices a via the Alert and Notification Engine 650. The notification could be anything including but not limited to an e-mail, an SMS, a mobile text message, and/or a web-based alert such as a social network message.

### Machine Learning using the Back End systems

In certain example embodiments, the back end systems, including various servers and/or data storage, here may use various aspects of machine learning and analytics in order to make decisions of how and when to contact individual clients. For example, the systems may utilize machine-learning protocols that are used to generate heuristics and predictions, based on known properties learned from training data. The systems may implement supervised learning protocols, unsupervised learning, semi-supervised learning protocols, transduction protocols, using example inputs and their desired outputs, given by a “teacher”, with the goal to learn a general rule that maps inputs to outputs.

A teacher may be a human domain expert who has developed a decision making system to determine outcomes given specific inputs. For example, in the casino gaming industry, human experts are used to plan a gaming layout based on varied inputs like expected clientele, location of in casino restaurants, casino entertainment and time of year. In this manner, the inputs are too varied for a machine alone to make decisions and need a teacher to provide a base set of rules by which to begin making decisions.

In such a way, the systems here may be configured to dynamically generate the one or more analytics responsive to received consumer event information associated with the user defined events to classify consumer event information using machine-learning protocols employing one or more classifiers. Non-limiting examples of classifiers include bayesian networks, decision trees, gaussian process classifiers, k-Nearest Neighbors (k-NN), LASSO, linear classifiers, logistic regression, multi-layer perceptron, naive bayes, radial basis function (RBF) networks, etc.

For example, the systems may operate on unlabeled examples, i.e., input where the desired output is unknown. In such an example, an objective may be to discover structure in the data, not to generalize a mapping from inputs to outputs. The system may then be used to combine both labeled and unlabeled examples to generate an appropriate function or classifier for the event and e-commerce data collected. Transduction and/or transductive inference may be used to try to predict new outputs on specific and fixed (test) cases from observed, specific (training) cases.

Certain examples may be used to partition the consumer event information into the one or more information subsets using one or more machine-learning toolboxes. Non-limiting examples of machine-learning toolboxes include dlib kernels, efficient learning, large-scale inference, and optimization (Elefant), java-ml, kernel-based machine learning lab (kernlab), mlpy, Nieme, Orange (University of Ljubljana), pybrain(Python), pyML (Python), SciKit.Learn (Python), Shogun, torch7, Waikato Environment for Knowledge Analysis (Weka), and the like.

The system may partition the consumer event information into the one or more information subsets using a spectral learning protocol electronically determining a rate of deviation from threshold condition. The systems may be used to partition the consumer event information into the one or more information subsets using one or more of built-in model selection strategies, classification, domain adaptation, image processing, large scale learning, multiclass classification, multitask learning, normalization, one class classification, parallelized code, performance measures, pre-processing, regression, semi-supervised learning, serialization, structured output learning, test framework, and/or visualization. Further, systems may be used to generate the one or more analytics responsive to received consumer event information associated with the event to partition the consumer event information into the one or more information subsets using a clustering protocol and generate the one or more analytics responsive to received consumer event information associated with the browser event.

In certain example embodiments, a device includes circuitry configured to communicate an alert, a notification, and/or a push notification responsive to a comparison of the one or more analytics to a threshold condition. A notification could be anything including but not limited to an e-mail, an SMS, a mobile text message, and/or a web-based alert such as a social network message or a message specific to an application running on a user client device.

### In-Store Beacon Examples

In certain example embodiments, retailers may equip their store with wireless communication systems such as Bluetooth Low Energy (BLE), an Apple iBeacon technology, etc., in order to communicate with the user equipment of the customer users who are walking in their store or nearby. Referring to FIG. 1, the beacons 114 could act as these location and/or communication beacons.

Using such systems, the location of the users could be discerned with relative accuracy. Thus, the systems here can be used to generate a customer flow map through retail locations where BLE beacons have been installed. By so identifying the location of the user, specific promotions and/or information could be pushed to an application running on their smart devices. Additionally, follow up contacts may be made in order to further target the customer user. In such a way, the systems may be configured to generate event-tracking information associated with a user-shopping event, and a retail component configured to dynamically communicate one or more parameters associated with the user shopping event to a remote network device.

Such location information could also be used to communicate with users in a follow up manner. For example, after they get home from the mall, a user receives an email from a store they walked by or shopped in. The email states “Hey, we saw you were checking out our latest deals on running shoes! We'd love to see you again soon! Bring in this coupon for 5% off of Brand X which you saw today! We even have your size in stock!” In such examples, the retail environment can be used to identify specific items that a particular customer user was interested in and maybe didn't purchase. By analyzing where a user was in a store, and how long they looked at different parts of the store, even more information can be ascertained and used to target and follow up with customer users.

Other examples include following up with online shopping examples and promotions, also based on the information gathered from the retail store. In the example above, instead of offering an in-store coupon, the system is able to push online deals to the customer user who can compare retailers or respond to one particular retailer.

In another example, a user walks past a restaurant and decides to go to another restaurant nearby. Because the first restaurant was able to detect the user walking past, the system can generate a push notification to the user. For example, “Daily Specials at Restaurant Y! We'd love to have you dine with us tonight! Buy 2 get one free appetizers are going on until 7 pm!” In such a way, a real time alert can be sent to a user, who may receive it and make a purchase decision based on new information.

The data that the systems can gather from the in-store experiences can be used in many of various ways. For example, embodiments here may be used to generate sales floor optimization based on the location and social network information data gathered from clients. Additionally or alternatively, example embodiments may be used to create a merchandising map of retail locations based on placement of beacons that allows a retailer to optimize their store based on the paths customers take through their store.

In another example, during operation, a customer enters a store with a client component installed on their smartphone. In an embodiment, as customer browses the store, the smartphone client receives BLE beacon signals from beacons stationed around the retail store. The example client component, such as a smartphone client, sends periodic information (e.g., beacon identification information, nearness to beacon information, date/time, identification of client information, and the like), to the systems here for analytics and location.

Using this example and employing the periodic information as digital breadcrumbs, systems here may be map the path a customer takes as they browse the physical store. And the information from that user could be presented to a retailer user via a dashboard interface and/or a dashboard application. Such dashboard interface may display information including a turn-by-turn path through a retail location and time spent when the client is within listening distance of the retailer's beacons.

Aggregating such information from various customer users could provide information to retailer users in order to help them with flow of traffic control, pushing customers to high value displays or merchandise, and for learning what interests the most customers. Maps of traffic could be constructed for analysis. Further, using social network information from each user, demographic information about the users could be found. For example, in a retail store, over time, users in the 20-25 age range walked to a certain display in the store more than all other displays, but users in the 40-50 age range walked to another. Maps of traffic based on certain parameters such as certain times, certain days, certain user demographics, etc. could be created and analyzed as well using such location information.

Also, an enterprise device can activate actions to be taken when a customer is within a given distance of a particular BLE beacon. For example, sale alerts, merchandise information, and commercials including celebrity endorsements could be sent. Thus, while looking at a pair of shoes, a customer receives a personalized commercial from a celebrity offering a buy one get one 25% off sale. Such customization can impact a consumers' decision to purchase right there in the store.

Further, a retailer server may identify a customer based on information received from a client device associated with the customer. In such a way, the store manager may be alerted to a highly valued customer on the sales floor. Alternatively or additionally, an enterprise device may generate notification in real-time indicative that a customer is in need of assistance on the sales floor based on interaction the customer has with the application on their mobile device.

In certain examples, actions include displaying a specific offer or advertisement on a kiosk/tablet or via a native notification on a client device. Other examples include an activation and the type of action displayed is based on a client device's proximity to a specific BLE beacon.

### Social Network Leverage Examples

Certain example embodiments of the systems and methods here could be used to tap into the individual user's social networks. Thus, by using a mobile application, and asking permission to access the user's social network information, the systems here could gather information regarding the likes and dislikes in order to target advertising, promotions, etc. to their user devices.

Further, by tapping into the social network, promotions could be shared with the friends of the users to whom promotions are targeted. Demographic information could be gathered from social network profiles as well—to customize alerts, offers, promotions and/or communications.

In order to incentivize sharing such information with the systems here, benefits may be offered for providing additional access to personal data, social network identities, etc.

### Online Examples

Certain example embodiments are able to interact with users online For example, clickstream data related to ecommerce, event data related to ecommerce, clickstream data related to marketing interactions with consumers, event data related to marketing interactions with consumers, clickstream data related to ecommerce and marketing interactions with consumers, event data related to ecommerce and marketing interactions with consumers may all be used to gather information about user interactions and shopping online.

Systems here may be used to gather this information through third party online shopping sites. Using an example e-commerce visitor interface to receive client event information (e.g., browser event information, shopping event information, retail event information, etc.) from a client device.

Examples of information associated with a client event include, but is not limited to, web pages viewed information, products viewed information, products added to shopping cart information, checkout status information, checkout process information, etc.

In certain example embodiments, systems here may include a dashboard interface. In such examples, the dashboard interface may be configured to track and display analytical information associated with the client event information. Non-limiting examples of client event information include pages viewed information, products viewed information, products added to shopping cart information, checkout status information, checkout process information, and the like.

In such example embodiments, the dashboard interface may be configured to communicate to a client device an alert, a notification, or a push notification responsive to exchanging client event information with the remote enterprise device. Thus, the dashboard interface may communicate to a client device an alert, a notification, or a push notification based on a real-time comparison of at least one parameter associated with the client event information to at least one parameter associated with enterprise-specific threshold criteria. In example embodiments, the dashboard interface is configured to receive analytical information from a marketing and analytics server device.

More Online Examples using Machine Learning

In certain examples, an administration client may be used to manage an e-commerce solution, manage inventory and product for an e-commerce store, create marketing campaigns, create marketing promotions, present analytical reports, etc. Alternatively or additionally, information from clients can be used for ratings information, reviews information, newsletter information, or blog information.

Systems and methods here may be used for collecting this data into the same data warehouse to be used for building campaigns and unique one-to-one experiences blurring the line between online and brick and mortar. Such an administration client may be referred to as a dashboard.

In certain example embodiments, the event-tracking information may include pages viewed information, products viewed information, products added to shopping cart information, checkout status information, checkout process information, and the like. In an embodiment, analytical information includes at least one real-time statistic generated based on one or more parameters associated with the client event information.

In some examples, a price match rule may be created if the incoming data stream contains GPS data, or other location data, indicating that the mobile device is not in a location owned by the retailer or store administrator.

Certain examples may allow for a user to receive a notification of an offer to purchase a product at a discount, from an e-commerce store, that expires within a target time, which is very short.

Online checkout processes

Systems and methods here may include gathering information from online checkout processes which may be used to inform the system and make decisions regarding communicating to consumer clients. Information indicative of a checkout process status for each step taken by a consumer, including address entry, credit card entry, discounts applied, including first visit of the checkout steps and final submission of payment information for purchase may be used. The system may partition the consumer event information into one or more information subsets. Circuitry may be configured to partition the consumer event information into the one or more information subsets using a machine-learning protocol to improve the percentage of consumers fully transacting and submitting purchase requests. Non-limiting examples of machine-learning protocols include classification protocols, clustering protocols, dimensionality reduction protocols, model selection protocols, optimization protocols, pattern recognition protocols, preprocessing protocols, ranking protocols, regression protocols, and the like. Further non-limiting examples of machine-learning protocols include feature selection protocols, independent component analysis protocols, missing feature protocols, multivariate protocols, natural language processing protocols, protocols using one or more kernels, structural output learning protocols. Further non-limiting examples of machine-learning protocols include those by supervised learning, unsupervised learning, reinforcement learning and data mining.

In certain example embodiments, the circuitry configured to communicate the alert, the notification, or the push notification responsive to the comparison of the one or more analytics to the threshold condition includes circuitry configured to actuate a social media based notification. Such circuitry may also actuate a push notification service. Notifications may be sent to the consumer or the administrator of the service.

Certain examples may allow the system to be responsive to the comparison of the one or more analytics to the threshold condition includes circuitry configured to actuate a time sensitive discount on a product to price the product below a price at physical retail location. This includes use of a web server device and a database server device supporting one or more databases. Non-limiting examples of databases include SQLite, MongoDB, MySQL, and the like.

In certain example embodiments, an enterprise device comprises a general purpose e-commerce server device managing one or more of products, filters, customers/visitors, retail promotions, events related to e-commerce transactions, analytics graphs and information related to website and e-commerce transactions, notification server devices related to e-commerce and events on website, and the like. In certain example embodiments, an enterprise device runs locally on customer server devices or is hosted by a different enterprise server device.

In certain examples, a browser-based client provides an end user, via a client device, with access to one or more applications through a web browser. For example, an e-commerce client provides an end user, via a client device, with access to remote network devices, applications, and the like through a web browser. In certain embodiments, the marketing and analytics server device manages paid services available to a plurality of usage tiers.

And some examples include a marketing and analytics server device with an event collection component to acquire and store event information from clients, event information from an enterprise server device, event information from enterprise partner server devices, and the like, and a notification component operable to direct communication with clients via websockets, sins, email, and the like.

Some examples include an analytics component—large datasets processing components, as well as reporting generation components, data mining components, and machine learning components.

### Auction Examples

In an embodiment, a low inventory auction component includes circuitry configured to allow customers to create alerts on items that are low in physical local inventory. In an embodiment, a low inventory auction component includes circuitry configured to allow a user of a client device to participate in real-time auction against other users of client devices. In an embodiment, retailers host campaigns through a hardware/software-based wizard, which is based on target criteria material to the retailer. In an embodiment, customers are enabled to participate in real-time auctions for inventory countdown to zero product on hand. In an embodiment, notifications are sent to subscribed customers via SMS, native notifications, websockets email, and the like. In an embodiment, auctions are created automatically based on predefined labeled criteria created by the retailer in the dashboard interface.

### Example Methods

In certain example methods, the systems here are configured to receive consumer event information associated with a client event; displaying one or more analytics responsive to receiving the consumer event information associated with the browser event; initiating an alert, a notification, or a push notification responsive to a comparison of the one or more analytics to a threshold condition.

In certain example methods, the systems here are configured to receive consumer event information associated with a client event; generate one or more analytics responsive to receiving the consumer event information associated with the browser event; communicate an alert, a notification, or a push notification responsive to a comparison of the one or more analytics to a threshold condition; communicate the alert, the notification, or the push notification responsive to the comparison of the one or more analytics to the threshold condition includes communicating inventory status information; communicate the alert, the notification, or the push notification responsive to the comparison of the one or more analytics to the threshold condition includes communicating information associated with shopping visitor activities on e-commerce site.

In certain example methods, the systems here are configured to generate event-tracking information associated with a client event; generate event-tracking information associated with the browser event by generating one or more of pages viewed information, products viewed information, or products added to shopping cart information; generate event-tracking information associated with the browser by generating one or more of ratings information, reviews information, newsletter information, or blog information; generate event-tracking information associated with the browser event by generating information indicative of a checkout process status; generate event-tracking information associated with the browser event includes generating information indicative that a checkout process has begun; generate event-tracking information associated with the browser event by generating information indicative that a checkout process has completed; send one or more parameters associated with the event-tracking information to a remote network device; receive a communication, a notification, or a push notification responsive to dynamically send the one or more parameters associated with the event-tracking information.

In certain example methods, the systems here are configured to receive from a client device event-tracking information associated with a user-shopping event based on detection of one or more beacons along a travel path at a physical retail location; generate a user-specific flow map through the physical retail location based on the event-tracking information; generate the user-specific flow map through the physical retail location based on the event-tracking information includes generating a travel route information that is time and date specific; generate a travel route information that is retail customer specific; generate the user-specific flow map through the physical retail location based on the event-tracking information includes generating heat map associated with a user-shopping event based on the event-tracking information; generate the user-specific flow map through the physical retail location based on the event-tracking information includes modifying a user-specific flow map based on detection of one or more beacons along a travel path at a physical retail location; modify a user-specific flow map based on detection of one or more beacons along a travel path at a physical retail location; update a user-specific flow map based on detection of one or more beacons along a travel path at a physical retail location; generate one or more event analytics associated with the user-shopping event; generate one or more heuristics associated with the user-shopping event; communicate an alert, a notification, or a push notification to the client device responsive to generating the user-specific flow map through the physical retail location; communicate an alert, a notification, or a push notification to the client device responsive to dynamically generating the user-specific flow map through the physical retail location includes communicating one or more parameters associated with a travel route through the physical retail location; communicate an alert, a notification, or a push notification to the client device responsive to dynamically generating the user-specific flow map through the physical retail location includes communicating one or more offers or promotions associated with products along a travel route through the physical retail location.

### CONCLUSION

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as 1PROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A system for gathering data comprising,
a server computer in communication with at least one beacon, a data storage and a mobile device via a network, the server computer configured to,
receive from the mobile device event-tracking information associated with a user shopping event based on detection of the at least one beacon at a physical retail location;
generate a user-specific flow map through the physical retail location based on the event-tracking information;
wherein the flow map indicates travel route information that is time and date specific;
generate one or more event analytics associated with the user-shopping event;
communicate an alert notification to the mobile device responsive to generating the user-specific flow map through the physical retail location; and
cause storage of, in the data storage, one or more parameters associated with the travel route through the physical retail location.

2. The system of claim 1 wherein the alert is a text message.

3. The system of claim 1 wherein the beacon is a WiFi access point.

4. The system of claim 1 wherein the server computer is further configured to send the alert to the mobile device via the at least one beacon.

5. The system of claim 1 wherein the server computer is further configured to send the alert to the mobile device via a cellular connection with the mobile device.

6. The system of claim 1 wherein the location information of the mobile device over time is stored in the data storage.

7. The system of claim 1 wherein the server computer is further configured to,
generate one or more heuristics associated with the user-shopping event.

8. The system of claim 1 wherein the event analytics includes Gaussian process classifiers.

9. The system of claim 1 wherein the event analytics includes linear classifiers.

10. The system of claim 1 wherein the event analytics includes logistic regression.

11. A system for gathering data comprising,
a server computer in communication with at least one beacon, a data storage and a mobile device via a network, the server computer configured to,
receive from the at least one beacon at a physical retail location, a location information of the mobile device;
generate a user-specific flow map through the physical retail location based on the location information;
wherein the flow map indicates travel route information that is time and date specific;
generate one or more event analytics associated with the location information;
generate one or more heuristics associated with the location information;
communicate an alert notification to the mobile device responsive to generating the user-specific flow map through the physical retail location; and
cause storage of, in the data storage, one or more parameters associated with the travel route through the physical retail location.

12. The system of claim 11 wherein the server computer is further configured to send the alert to the mobile device via the at least one beacon.

13. The system of claim 11 wherein the server computer is further configured to send the alert to the mobile device via a cellular connection with the mobile device.

14. The system of claim 11 wherein the location information of the mobile device over time is stored in the data storage.

15. A method of gathering data comprising,
via a server computer in communication with at least one beacon, a data storage and a mobile device via a network,
receiving location information from the beacon at a physical retail location;
generating one or more event analytics associated with the user-shopping event;
deciding, based on the analytics, which alert notification to send to the mobile device;
communicating the alert notification to the mobile device; and
save the decision and analytics, specific to this mobile device, on the data storage.

16. The method of claim 15 further comprising, sending the alert to the mobile device via the at least one beacon.

17. The method of claim 15 further comprising, sending the alert to the mobile device via a cellular connection with the mobile device.

18. The method of claim 15 further comprising, storing location information of the mobile device over time in the data storage.

19. The method of claim 15 further comprising, generating a user-specific flow map through the physical retail location based on the event-tracking information.

20. The method of claim 15 further comprising, causing storage, in the data storage, of one or more parameters associated with the travel route through the physical retail location.
